(19) United States
(12) Patent Application Publication
(10) Pub. No.: US 2003/0140911 A1
(43) Pub. Date: Jul. 31, 2003

(54) POWER ENHANCEMENT CONTROL SYSTEM FOR COMBUSTION ENGINE

(76) Inventor: Jui-Yang Lo, Junghe City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/057,975

(22) Filed: Jan. 29, 2002

(51) Int. Cl. F02B 23/00

(52) U.S. Cl. 123/585

(57) ABSTRACT

An oil-saving accelerating control device of eliminating the black smoke mainly comprising a power-increasing means and a pressure increasing auxiliary device in cooperative the inlet branch of the gas-combustion engine, by means of the high-voltage output produced by the power increasing means, after the air within the metal inside is being purified, it produces more oxygen to increase the efficiency of the gas-combustion engine and thus it saves the fuel as well as increasing the power; besides, by cooperative with the pressure-increasing device, when the power-increasing means is acting, it collects more oxygen on the same time on acting the power-increasing means, whereas the operator could provide more oxygen to the effect of gas-combustion engine for usage through controlling a initiation switch.

### BACKGROUND OF THE INVENTION

1. Field of the Invention

This invention relates to an oil-saving accelerating control device of eliminating black smoke, especially refers to the technology of which fills the oxygen into one high-pressure gas-storage bottle with single air flowing pump and could suitably control such oxygen by means of operation.

2. Description of the Prior Art

Traditional technology of increasing the power of the combustible engine is SUPER CHARGE and TURBO CHARGE, and these two ways should be the additional function by original design, the general car without adding such design could not increase the required power and there is no benefit toward the improvement of natural environmental pollution.

Another traditional way of increasing the power of the combustible engine is to provide more clean air with the cylinder wherein the oxygen-containing amounts of the cold air is higher than the hot air, that is, inhale the air outside the car entering into the branch tube 3 and enters into the cylinder 5 for combustible explosion schedule with an auxiliary device 6 setting the air cleaner 62 and the air pump 61; however, such traditional device could not control effectively toward the black smoke produced after the power is being delivered by the gas-combustible engine.

From this we could see that the above-mentioned traditional object is not a perfect design and need urgently to be bettered; the inventor of this invention thinks to better and innovate due to there still is drawback for the above-mentioned device of increasing the power of the gas-combustible engine and studies many years and finally successfully research and complete this oil-saving accelerating control device of this invention.

### SUMMARY OF THE INVENTION

The main purpose of this invention is to provide an oil-saving accelerating control device of eliminating the black smoke wherein, by means of the set-up of the pressure-up auxiliary device, it could storage the oxygen into the high-pressure gas-storage bottle with single air flowing pump when general usage of the power increasing means so that the high pressure storage bottle could provide more oxygen for combustible engine usage when there is requirement of the engine to provide more power for usage.

Another purpose of this invention is to provide a way of which it is suitable for each kind of gas combustible engine to increase the power; which is, it uses one power increasing device which principle is to clean the air by way of utilizing the high-voltage electrolyte air, next it is guided into the combustible chamber (cylinder) of the gas-combustible engine to increase the combustion efficiency of the fuel so as to elevate the power of the gas-combustible engine, the setting of the power-increasing device could make engine starting more easily and the power could increase up to 20% which saves the consumption of the fuels, decreases the black smoke and the production of the oil black smoke and the carbon compound and has the advantage of increasing the lifetime of the engine and the catalyst converter which is welcome by people. However, in order to let the engine under optimum status, said power-increasing device starts-up with full time upon the engine starting-up, and the produced oxygen could be filled inside the gas storage bottle with high-pressure compression; when there is needed for the engine to produce more power, the oxygen inside the gas storage bottle could enter directly into the engine combustion chamber (cylinder) to make the engine more impact through the control of switch.

Another purpose of this invention is to provide an oil-saving accelerating control device of eliminating the black smoke which, by means of the convenience of suitably supplying the oxygen to the gas-combustible engine through initiating the switch control gate valve and the pressure gauge could be displayed on the monitoring of the panel so that the operator could completely seize the status of the fuel and the performance of cars.

Another purpose of this invention is to provide an oil-saving accelerating control device of eliminating the black smoke wherein on the output terminal of the high-pressure loop device settled by said power-increasing means there settles the combustion engine inlet branch and if it is not made of electric-conducting material, it could set one metal conducting sheet with grounding on the inner tube wall of the inlet branch so as to achieve the high-pressure output terminal of the high voltage loop device and it could purge more air by producing more oxygen with the metal conducting sheet.

The oil-saving accelerating control device of eliminating black smoke for achieving the above-mentioned purpose of this invention comprises:

A power-increasing means which is a high-voltage loop device; there connects a power input initiator on the input terminal of said high-voltage loop device; there produces high voltage on the output terminal of said high-voltage loop by means of the initiation of said power input initiator;

A pressure increasing auxiliary device, said pressure increasing auxiliary device further comprises a directional control valve; there connects one single-directional air flowing pump with pipelines on said directional control valve, and there connects high-pressure gas storage bottle with pipeline on said single-directional air flowing pump, and there settles another outlet pipe on said high-pressure gas-storage bottle; on suitable position of said outlet pipeline there settles a flow rate control valve, there connects one start-up switch on said flow rate control valve, said flow rate control valve is connecting to an initiating switch which is settled on the position where the driver is easily to control it; by means of the initiation of said initiating switch, the close status of the flow rate control valve could be changed; and there settles a pressure gauge on the proper position of the pipeline of the single-directional air flowing pump and the high-pressure gas storage bottle; said pressure gauge could control if the control terminal of said directional control valve or the single-directional air flowing pump is initiated which pressure status is displayed on the panel;

The structure as the above-mentioned wherein the output terminal of said high-voltage loop is settled inside the proper place of the inlet branch of the cylinder of the combustion gas engine and more oxygen gas could be produced inside the output terminal of the high-voltage loop and the inner tube wall of the metal of the inlet branch wherein if the inlet branch is non-electrolyte, there settles one grounding metal electrolyte sheet on the inner tube wall of the inlet branch, and the directional control valve of said pressure-increasing auxiliary device is connected onto the inlet branch with pipeline which connecting position is between the output terminal of high-voltage loop and the outlet pipeline of said gate valve is connecting on the proper place inside the cylinder.

### BRIEF DESCRIPTION OF THE DRAWINGS

The drawings discloses an illustrative embodiment of the present invention which serves to exemplify the various advantages and objects hereof, and are as follows:

FIG. 1 is the hint figure of traditional power-increasing means.

FIGS. 2(A) and (B) are the preferred embodiment visual figure of the oil-saving accelerating control device of eliminating black smoke of this invention;

FIG. 3 is the second embodiment figure of the oil-saving accelerating control device of eliminating black smoke; and

FIGS. 4(A) and (B) are the third embodiment figure of the oil-saving accelerating control device of eliminating black smoke;

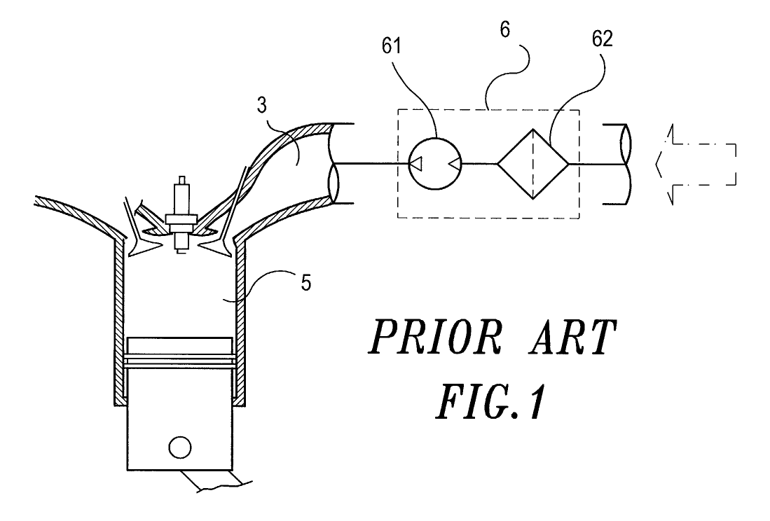

### DETAILED DESCRIPTION OF THE PREFERRED EMBODIMENT

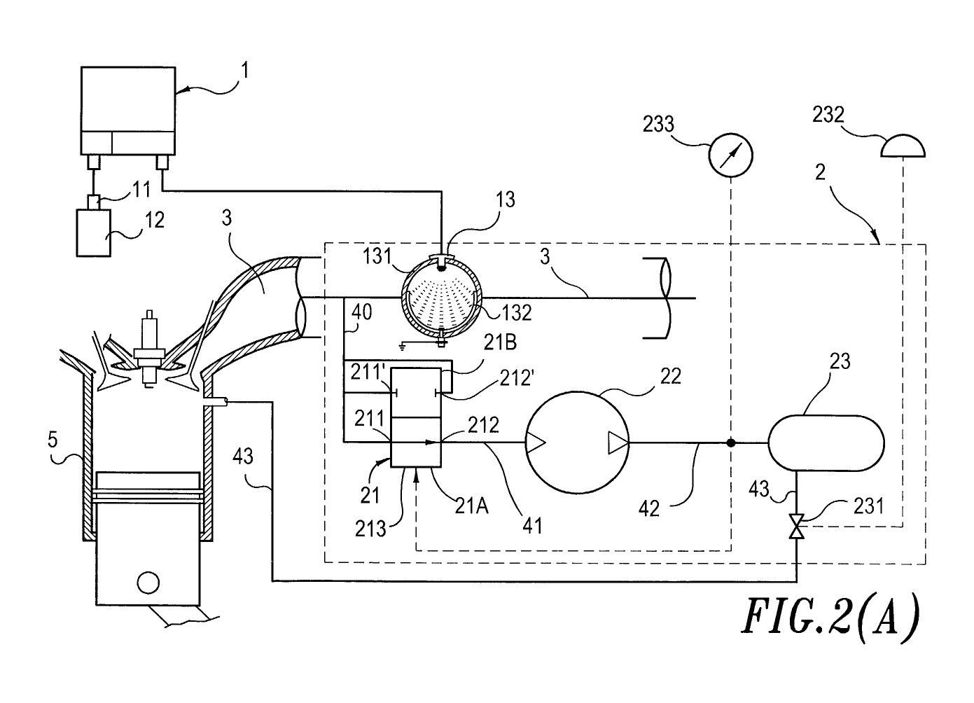

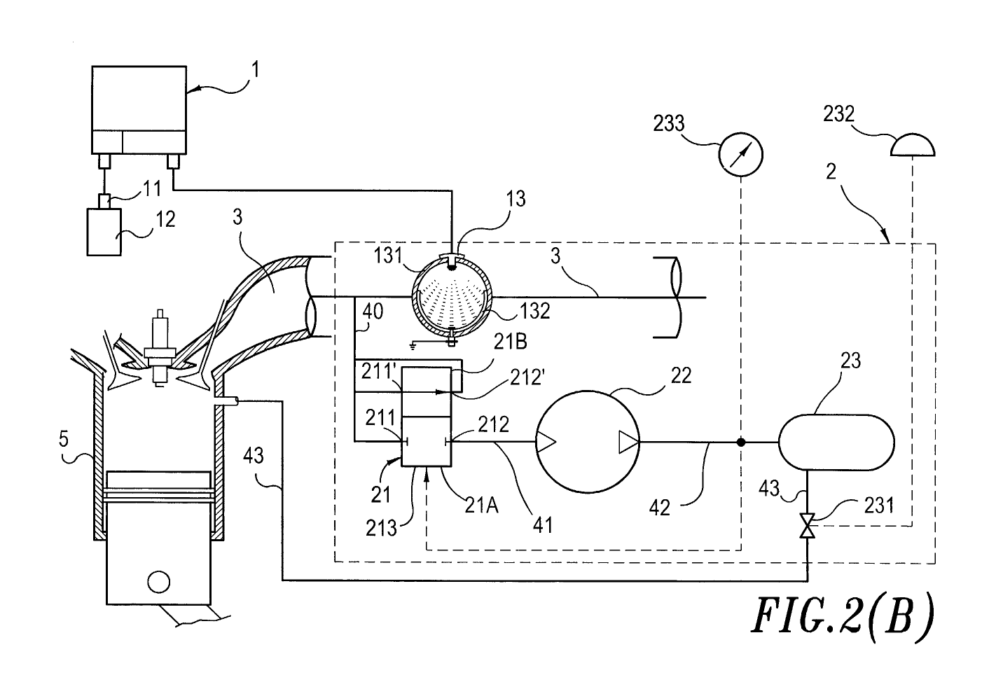

Please see FIG. 2(A) and 2(B). FIG. 2(A) and 2(B) are the preferred embodiment figure of the oil-saving accelerating control means of eliminating black smoke of this invention; FIG. 2(A) is the practice status before initiating the pressure-increasing auxiliary device; FIG. 2(B) is the practice status after initiating the pressure-increasing auxiliary device; this invention is mainly comprised of a power increasing means 1 and a pressure-increasing auxiliary means 2 in cooperative with the inlet branch 3 of the gas-combustion engine; said power-increasing means 1 is a high-voltage loop device; the input terminal of said high-voltage loop device is connecting a power input initiator 12, by means of the start-up of said power input initiator 12, the output terminal 13 of said high-voltage loop 13 is producing high voltage; said pressure-increasing auxiliary means 2 is comprised mainly of a directional control valve 21, a single-directional air flowing pump 22 and a high-pressure gas-storage bottle 23, said directional control valve 21 is set to be 2/2 type; that is, there are two inlet/outlet on the valve body (as shown in the inlet 211, 211′, outlet 212, 212′ of the figure), and there are two specific status 21A and 21B; there connects a single-directional air flowing pump 22 on said directional control valve 21 with pipeline 31, there besides connects a high-pressure gas-storage bottle 23 with the pipeline 42 on said single air flowing pump 22, and there settles one outlet pipeline 43 on said high-pressure gas storage bottle 23, there settles one flow rate control valve on proper position of said outlet pipeline. ( as shown in the preferred embodiment of FIG. 2(A) and 2(B)), which is the application of a gate valve 231), said gate valve 231 is connecting to an initiating switch 232; through the acting of said initiating switch 232 the closed status of the gate valve 231 could be changed; and on the proper position of the pipeline of the single-directional air flowing pump 22 and the high-pressure gas-storage bottle there settles a pressure gauge; said pressure gauge 233 could change the status of the initiation of the control terminal 231 of said directional control valve 21 and the single-directional air flowing pump 22 according to the setting point of the pressure wherein the pressure status display of the pressure gauge 233 could be installed on the panel for inspection by operators; when the high-pressure loop output terminal 13 of said power-increasing means 1 is installed, inside the inlet branch 3 of the cylinder 5 of gas combustion engine and when the power input initiator 12 opens, the output terminal 13 of the high-voltage loop could make the metal conducting sheet 132 of the inlet branch 3 producing more oxygen; and the directional control valve 21 of said pressure-increasing auxiliary means 2 is connected with the inlet branch 3 with pipeline 40; said connection site is between the high-voltage loop output terminal 13 of the power-increasing means 1 and the cylinder 5, and the outlet pipeline 43 of said gate valve 231 is connecting inside the cylinder 5; so, when the pressure gauge does not reach the setting level (i.e., the high-voltage gas storage bottle does not reach the threshold pressure), the directional control valve 21 is on status site 21A, i.e., the inlet 211 and the outlet 212 is open, said single-directional air flowing pump 22 is on “always open” status as shown in FIG. 2(A), and there could produce more oxygen on the metal conducting sheet 132 of the inlet branch 3 of the output terminal 13 of the high-voltage loop, said oxygen could be transported by pipeline 40 through the acting of the single-directional air flowing pump 22 except for supplying the usage of the inlet branch 3; and when the pressure gauge 233 reaches the required level (i.e., the high-voltage gas-storage bottle 23 reaches the threshold pressure), the directional control valve 21 is on status position 21B, i.e., the inlet 211′ and the outlet 212′ is open, whereas the single-directional air flowing pump 22 is on ‘always close’ status as shown in FIG. 2(B), the whole pressure-up auxiliary device 2 stop acting; and whether if there is acting on the pressure-up auxiliary device 2, if the inner pressure inside the high-pressure gas storage bottle 23 higher than the pressure inside the cylinder 5 which is the inlet schedule of the cylinder 5, the operator could switch the status of ‘close’ or ‘open’ through initiating the switch 232; when the operator switches the status of ‘open’ of gate valve 231 by means of initiating the switch 232, the oxygen storage inside the high-pressure gas storage bottle 23 could enter into the cylinder through the outlet pipeline 43 to supply the cylinder 5 on the usage of combustion schedule; otherwise, when the user switches the closed status of the gate valve 231 by initiating the switch 232, the oxygen storage inside the high-pressure gas storage bottle 23 is under storage status.

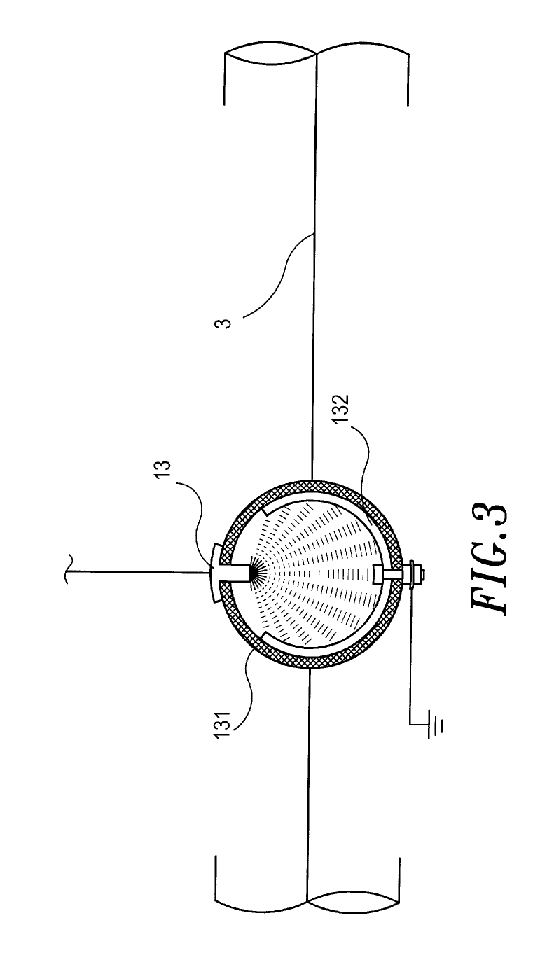

Besides, what is worth mentioned is, since the advance progress in science and technology, the gas-entering branch 3 of the gas-combustion engine is not necessarily made of fine conducting materials such as rubber tube or plastic tubes, this invention could set up one grounding electric-conducting sheet 132 on the inner tube wall 131 of the inlet branch 3 in cooperative with the output terminal of the high-voltage loop of said power-increasing means 1 (Please refers to FIG. 3), so, even the inlet branch 3 is not made of fine conducting material, it also could make the output terminal 13 of high-voltage loop of the power-increasing means 1 and the corresponding metal conducting sheet 132 which makes the air more clean.

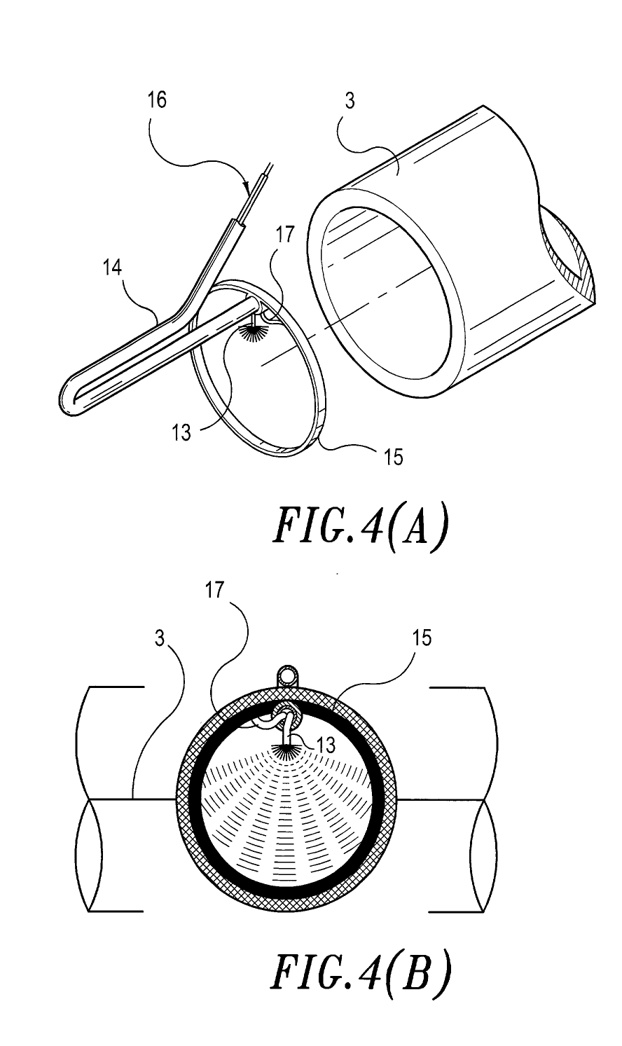

However, by means of practice as the above-mentioned ways, the user needs to drill the hole on the inlet branch 3 so that the output terminal 13 of the high-voltage loop of the power-increasing means 1 could be placed onto the inlet branch 3 to interact with the metal conducting sheet 3; so, this invention could make use of a bendable hollow soft tube 14 to settle the positive and negative pole electric wires through the hollow soft tube 14 for avoidance of the inconvenience of the users who need to drill the hole on the inlet branch 3 (Please refer to FIG. 4(A) and FIG. 4(B), and the positive and negative pole wires 16 is to be penetrated inside the hollow soft tube 14, and the negative pole output terminal 17 is to be fixed onto the metal ring 15 on the hollow soft tube 14 whereas the positive pole output terminal 13 is fixed and hanged inside the metal ring 15, and it interacts with the negative pole output terminal 13; by ways of this method the acting pole output terminal 13, 17 and the metal ring 15 to solve the inconvenience of the users who are in need of drilling the pole on the inlet branch 3.

The oil-saving accelerating control device of eliminating the black smoke provided by this invention has the following advantages in comparison with the above-mentioned traditional technologies:

(1) Even if the inlet branch of the gas-combustion engine is not made of fine electric-conducting material, by ways of the practice of this invention, it still could achieve the effect of purifying the air by ways of the high-voltage loop terminal of the power increasing means in cooperative with the metal electric-conducting sheet.

(2) Even if the traditional power-increasing means stop acting such as failure, by means of the setting up of this invention the operator still could use the spare-storage oxygen through initiating the switch and start-up the gate valve which still achieves the result of using the power-increasing means.

(3) This invention could be used only just re-installed the existing gas-entering mechanism to achieve the high-efficiency power source.

(4) The practice of this invention could completely own the advantage of power-increasing means.

Many changes and modifications in the above-mentioned embodiment of this invention can, of course, be carried out without departing from the scope thereof. Accordingly, to promote the progress in science and the useful arts, the invention is disclosed and is intended to be limited only by the scope of the appended claims.

What is claimed is:

1. An oil-saving accelerating control device of eliminating the black smoke comprising:
A power increasing means which is a high-voltage loop device, there connects one power input initiator on the output terminal of said high-voltage loop device, the output terminal of said high-voltage loop could produce high-voltage by means of the initiation of said input initiator;
A pressure-increasing auxiliary means wherein it further comprises a directional control valve which connects one single-directional air flowing pump with pipelines, there connects a high-pressure gas-storage bottle with said single-directional air flowing pump, and there besides settles one outlet pipeline with said high-pressure gas-storage bottle, on the proper position of said outlet pipeline there settles a flow rate control valve, there connects an initiation switch with said flow rate control valve, the closed status of the flow rate control valve could be changed through the acting of said initiation switch, and there settles a pressure gauge on the proper position of the pipeline of the single-directional air flowing pump and the high-pressure gas-storage bottle which could control the control terminal of said directional control valve and the status of initiation of the single-directional air-flowing pump according to its pressure setting valve;
The mechanism as above-mentioned that the output terminal of said high-voltage loop is settled inside the proper position of the inlet branch of the cylinder of the gas-combustion engine, said inlet branch is made of the electric-conducting metal, when the power input initiator starts, the output terminal of the high-voltage loop could produce more oxygen with the tube wall of the inner metal of the inlet branch, the directional control valve of said pressure-increasing auxiliary device is connected with the inlet branch with pipeline wherein said connection position is between the output terminal of the high-voltage loop and the cylinder and the outlet pipeline of said gate valve is connected to the proper position inside the cylinder.

2. The oil-saving accelerating control device of eliminating the black smoke as mentioned in claim 1, wherein the status of the pressure gauge of said pressure-increasing auxiliary device is shown on the panel.

3. The oil-saving accelerating control device of eliminating the black smoke as mentioned in claim 1, wherein the initiation switch of said gate valve is settled on the position where the user is easily to control and touch.

4. The oil-saving accelerating control device of eliminating the black smoke as mentioned in claim 1, wherein said flow rate control valve is a gate valve.

5. The oil-saving accelerating control device of eliminating the black smoke as mentioned in claim 1, wherein if the inlet branch of said gas combustion engine cylinder is made of non-metal, there could settle one grounding metal electric-conducting sheet on the inner tube wall of the inlet branch of the output terminal of the high-voltage loop, said metal electric-conducting sheet could produce more oxygen with the output terminal of high-voltage loop to purify the air.

6. The oil-saving accelerating control device of eliminating the black smoke as mentioned in claim 1, wherein the positive and negative pole output terminal of the high-voltage loop could be settled inside the hollow soft tube, and the negative pole output terminal is to be fixed on one metal ring on the terminal portion of the hollow soft tube, and it interacts with the negative pole output terminal connecting on the metal ring through the positive pole output terminal, which method could insert the acting electrode output terminal and the metal ring according to the shape of the inlet branch by means of the principle of the bending of the soft tube to solve the inconvenience of drill-hole on the inlet branch.
